(19) United States
(12) Patent Application Publication
(10) Pub. No.: US 2002/0075901 A1
(43) Pub. Date: Jun. 20, 2002

(54) Bandwidth management for tunneling servers

(76) Inventors: Bruce Perlmutter, Boston, MA (US); Qiang Fu, Waltham, MA (US); Jing Xiang, Acton, MA (US)

Correspondence Address: DENIS G. MALONEY, Fish & Richardson P.C., 225 Franklin Street, Boston, MA, 02110-2804, US

(21) Appl. No.: 09/740,052

(22) Filed: Dec. 19, 2000

(51) Int. Cl. H04J 3/16; H04J 3/22

(52) U.S. Cl. 370/468

(57) ABSTRACT

Allocation of bandwidth to a link which is remotely displaced from a server is described. The link need not directly connected to the server. The server includes a process to assign a portion of the bandwidth to at least one application group; and count packets belonging to the application group that pass through the server. The server can be a VPN server that authenticates packets. Each application group includes packets that share a pre-defined configuration. Accordingly, the server combines bandwidth management and packet authentication with little overhead.

### TECHNICAL FIELD

This invention relates to bandwidth management, and more particularly to a method and a system for a server to manage bandwidth.

### BACKGROUND

Internet applications require various degrees of security and quality of service. For example, a company may require a high degree of security for distributing its confidential business data to authorized users across the Internet. To prevent unauthorized intruders, the business data is encrypted before its distribution, and is decrypted after received by an authorized user. The Internet, in this example, can be viewed as a Virtual Private Network (VPN) that carries secured VPN packets over a public communication infrastructure. Authentication measures employed by a VPN server, including encryption and decryption, allow confidential information to be sent over the Internet as secure as over high-cost proprietary or leased lines.

VPN servers employ a tunneling technique that enables one network to send its data to a destination via another network. Assume that a company has several sites connected by the Internet, and each of the sites uses Ethernet protocol for local connections. The tunneling technique encapsulates the Ethernet protocol within packets carried by the Internet. To the Internet, the packets appear just like any other packets whose headers are in standard IP (Internet Protocol) format. The contents of the packets are meaningful only to their sender and receiver, but not to other network devices (e.g., routers) along the communication path connecting the sender and the receiver.

As demand for high performance communication grows, VPN packets often require different classes of service according to priorities. One may assign usable bandwidth to a group of VPN packets according to its priority and service requirements. For example, a company may desire to allocate more bandwidth to a VPN group (e.g., finance department) than to another VPN group (e.g., remote access user group) due to their relative importance to the company's operations.

However, as described above, routers along the communication path do not understand the VPN packet contents and cannot distinguish VPN groups.

### SUMMARY

Therefore, routers cannot provide the differentiated classes of service, unless significant modification is made to router functions. To consistently modify the routers across the Internet to implement different service requirements will require a tremendous overhead, and may cause interoperability problems in a multi-vendor system.

According to an aspect of the present invention, a method for a server to manage bandwidth of a link not directly connected to the server includes assigning a portion of the bandwidth to at least one application group; and metering packets belonging to the application group.

According to an aspect of the present invention, a system for managing bandwidth of a link includes a server not directly connected to the link; a contention pool having a portion of the bandwidth for at least one application group; and a meter for metering the packets belonging to the application group.

Embodiments of the above aspects of the invention may include one or more of the following features.

The server is a VPN server, which authenticates, encapsulates, and de-encapsulates the packets. The server is directly connected to other links having larger bandwidth than the bandwidth of the link managed by the server. Packets of an application group share a pre-defined configuration. The packets contend equally for a portion of the bandwidth assigned to their application group.

Metering the packets further includes rejecting the packets if the packets exceed the assigned portion of the bandwidth. Metering the packets further includes metering flow rate of the packets through the server in either direction. The method of the server further includes allowing a user to specify the bandwidth of the link, or the assigned portion of bandwidth from a user interface.

Embodiments may have one or more of the following advantages. The VPN servers efficiently and conveniently manage bandwidth for application groups and perform authentication. An application group with higher priority can be allocated with more bandwidth than other application groups. The bandwidth for which packets of application groups are contending is the bandwidth of a link vulnerable to congestion. Accordingly, the servers are able to manage the bandwidth of links even though the links are not directly connected to the servers.

Other features, objects, and advantages of the invention will be apparent from the description and drawings, and from the claims.

### DESCRIPTION OF DRAWINGS

FIG. 1 is a network diagram illustrating a corporate office having a server connected to a branch office and remote users via a network;

FIG. 2 is an example of allocated bandwidth for access links and LAN link of the server;

FIG. 3 is a flow diagram illustrating packet metering process performed by the server.

Like reference symbols in the various drawings indicate like elements.

### DETAILED DESCRIPTION

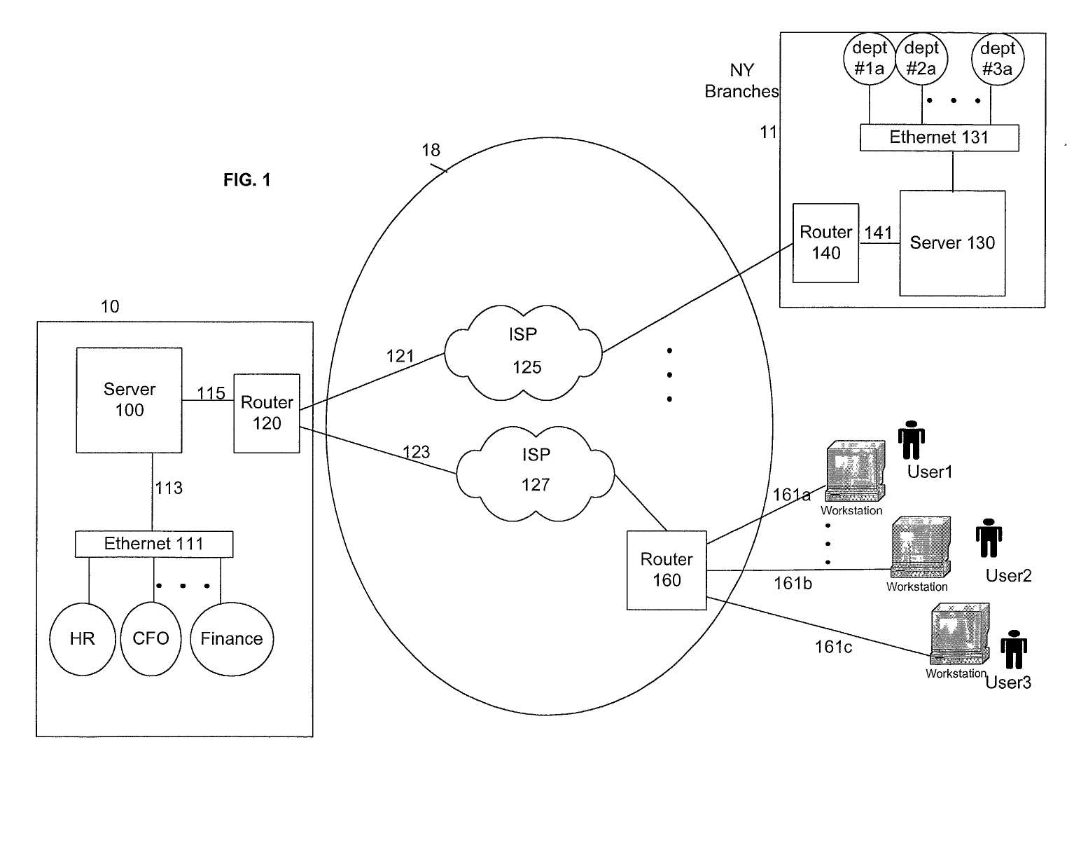

Referring to FIG. 1, a corporate office 10 of a company in Boston is connected to New York branches 11 and a number of remote users 161a, 161b and 161c via network 18. The company receives Internet service from two Internet Service Providers 125 and 127 (ISPs), e.g., AT&T and UUnet. Each office is connected to an ISP via an access link and a router. For example, corporate office 10 is connected to ISP 125 and 127 via respective access links 121 and 123, and a router 120.

Access links 121, 123, and 141 are dedicated links to the company. The access links are typically TI links that provide communication speed of 1.5 Mbits/sec (mega bits per second). Access links with higher speed than TI are also possible. Routers 120, 140 and 160 perform TCP/IP flow control that may cause packets to be dropped when their respective access links are congested. If a packet is not dropped, it will eventually be forwarded to a destination server, i.e., server 100 and 130.

Servers 100 and 130, in one scenario, are CES (Contivity® Extranet Switch) servers manufactured by Nortel Networks for use in a Virtual Private Network (VPN). The CES servers implement authentication and tunneling techniques to allow connections to N.Y. branches to appear as private circuits for the company. When server 100 authenticates packets, packets that share a pre-defined configuration, such as a connection identifier, are assigned to the same application group. An application group is, for example, a branch office tunnel or a remote access tunnel.

A network manager of the company may want to allocate a portion of bandwidth to a certain application group. For example, the company may want to assign the highest priority, thus the largest portion of bandwidth, to packets related to N.Y branches 11. However, none of the routers 120, 140 or 160 has any notions of application groups. On the contrary, because CES servers are required to perform authentication based on configurations, the CES servers can conveniently and efficiently manage bandwidth for the application groups.

However, the CES servers do not directly connected to a link that is likely to be congested. Typically, a CES server is connected to a router and a local area network (LAN) via high-speed links. For example, server 100 is connected to router 120 via link 115, and connected to an Ethernet 111 via link 113. Links 113 and 115 are both high-speed LAN links with typical speed of 10 or 100 Mbits/sec. In comparison, access links 121 and 123 to which router 120 is directly connected have a typical speed of 1.5 Mbits/sec and therefore are more vulnerable to congestion than link 115. Similar, Ethernet 111, connecting departments of corporate office 10, supports inter-departmental traffic in addition to inter-office traffic that flows through server 100 and links 113 and 115. Due to the absence of direct connections to Ethernet 111, access links 121 or 123, server 100 may not be able to effectively prevent congestion events on these links, or reduce its transmission speed according to application group priorities when congestion events occur.

A bandwidth management process implemented on server 100, as described in detail below, allows the server to police bandwidth utilization on its associated links that are vulnerable to congestion. The associated links of a server generally include the server's access links to ISP circuits, and the LAN links on the server's site, e.g., link 111 for server 100. For the server to be effective in managing bandwidth, a network manager provides the server with specific information about the associated links. The specific information required by the server generally includes the application groups on each of the associated links, the available capacity of the associated links, and the required bandwidth for the application groups. Based on the required bandwidth, a network manager determines the bandwidth of a contention pool to which one or more application groups are assigned. Packets belonging to the application groups that are assigned to the same contention pool will contend for the same bandwidth. After the above information is specified and the contention pools are defined for each of the associated links, the server meters the flow rate of packets, i.e., the number of packet or bits that go through the server per unit time, for each contention pool.

The specific information provided to the server is described in detail as follows. For effective bandwidth management, a server has to know which application groups use which associated links. With respect to the LAN links, it is easy for a network manager to identify the application groups using the LAN links, because the LAN links are at the same office location as the server. As for the access links, although a company generally subscribes to multiple ISPs for redundancy or business reasons, each application group is assigned a fixed ISP for Internet connection based on the subscription paid for each application group. Therefore, the network manager knows from which ISP and access link, an application group will arrive.

In terms of available capacity of the associated links, the capacity of each link being allocated may not be the same as the actual bandwidth of the link. A network manager can specify an available capacity for each link from a virtual circuit configuration screen according to network constraints and traffic statistics of the link. For example, the network manager may decide to specify the capacity of Ethernet 111 as 6 Mbits/sec duplex, which is the available bandwidth for transmitting inter-office traffic. The specified duplex bandwidth means 6 Mbits/sec incoming and 6 Mbits/sec outgoing traffic, which is much less than the full capacity of 10 or 100 Mbits/sec.

On the other hand, the network manager can also subscribe to more capacity than what actually exists. If application groups of the link have light or bursty traffic, the bandwidth of the link will not likely be fully utilized all the time. Allocating the link to more application groups will improve the bandwidth utilization, because one application group can utilize idle bandwidth when others are experiencing low traffic volume or between bursts. However, when the bandwidth is oversubscribed, there is an increased chance that packets may be dropped. This could happen, for example, if all application groups burst data at the same time.

The required bandwidth of an application group is usually determined by its traffic volume and priority. The network manager may assign more bandwidth to an application group with higher traffic volume or higher priority.

Based on the required bandwidth and the available bandwidth of the link, the network manager assigns one or more application groups to a contention pool, and allocates a fraction of the link to the contention pool using the virtual circuit creation screen.

Contention pools act very similar to physical circuits that support the assigned workload for their respective application groups. All traffic from any branch office or remote access tunnel that are assigned to a contention pool has equal access to the bandwidth of the contention pool. For example, if a number of branch office tunnel are sharing a contention pool, and only one is transmitting traffic, that one branch office tunnel can burst up to the total bandwidth for the pool specified for by the network manager. If all the branch office tunnels wish to burst at the same time, they will contend equally for the bandwidth allocated to the pool. Application groups that should not contend equally for a fixed bandwidth should be placed into separate contention pools. The use of contention pools insures that an application have sufficient bandwidth for its operations despite bursts of traffic from other sources. For example, if users (user1 and user2) connected on links 161a and 161b were using high-speed broadband connections like cable modems, the users could consume all of the bandwidth on link 123, starving user3 on link 161c. However, if user3 is assigned to a separate contention pool from that assigned to user1 and user2, bursts from user1 and user2 will be limited; assuring that the connection to user3 can continue to work.

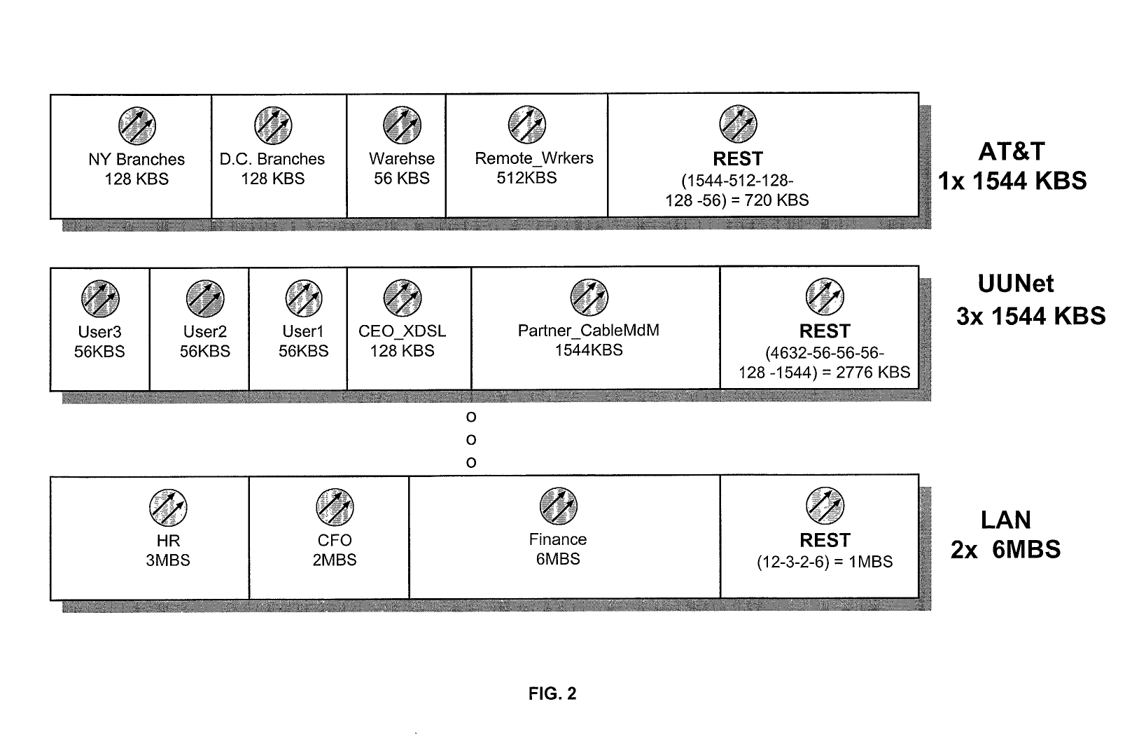

Referring to FIG. 2, a network manager allocates bandwidth for links 111, 121 and 123, including a specified bandwidth and an over-subscription rate for each link. The specified bandwidth and the over-subscription rate for links 111, 121 and 123 are 6 Mbits/sec, 1.544 Mbits/sec and 1.544 Mbits/sec, and 200%, 100% and 300%, respectively. The total bandwidth of all the contention pools of a link is the specified link bandwidth multiplied by its over-subscription rate.

In the example of FIG. 2, corporate office 10 is connected to additional branch offices and remote users compared to FIG. 1. In FIG. 2, access link 121 connects corporate office 10 to N.Y. branches 11, D.C. branches, and a corporate warehouse in New Jersey via AT&T ISP 125. In addition, about a hundred home office workers and another hundred roaming users also have access to corporate office 10 by using dialup Internet access accounts from AT&T. Access link 123, which is connected to the UUnet ISP 127, provides a communication path between corporate office 10 and remote users, the CEO, and partners. Furthermore, LAN link 111 connects server 100 to human resource, finance and CFO divisions within corporate office 10.

Based on an understanding of the application group workload, the network manager allocates the bandwidth of each of the associated link of server 100. Each slot in FIG. 2 represents a contention pool for one or more application groups. The name of each contention pool is related to an attribute of the application groups within that contention pool. For example, CEO_XDSL indicates that the contention pool is reserved for the CEO's high-speed XDSL modem.

All traffic coming from or going to server 100 is metered. Each contention pool has a flow meter that measures the flow rate for that contention pool to ensure that the flow rate does not exceed a limit specified by the network manager. As with the circuits, the flow meters are full duplex. A contention pool with a limit of 56 kbs of bandwidth supports 56 kbs incoming to server 100 and 56 kbs outgoing to the Internet.

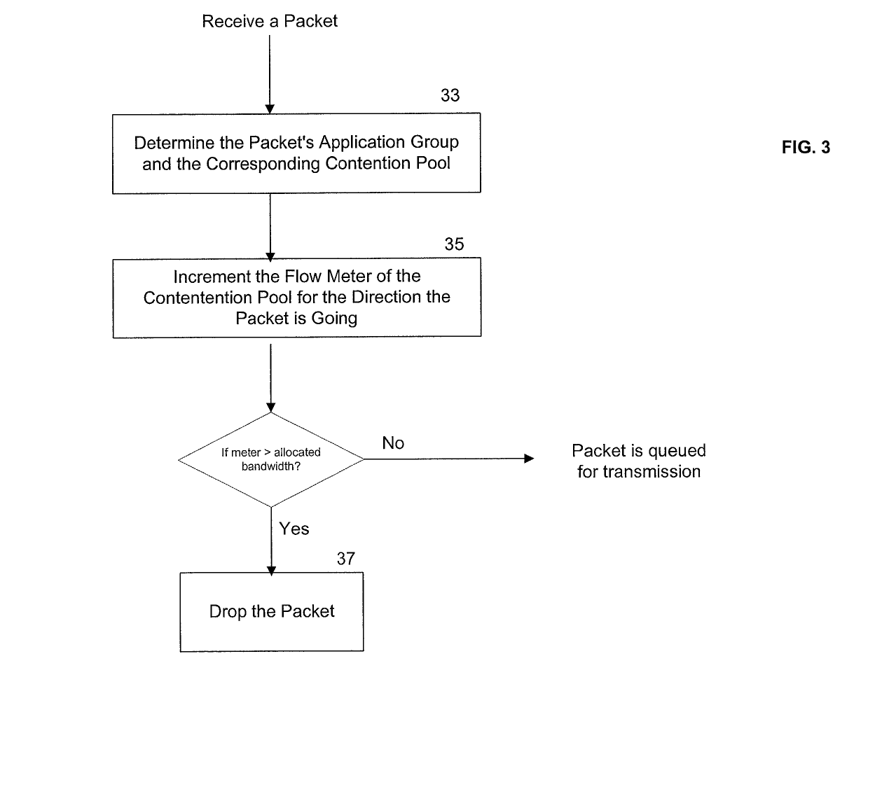

Referring to FIG. 3, a flow diagram illustrates the bandwidth management process implemented on server 100. The process assures that the traffic flowing out of the server be presented according to bandwidth requirement of each application group. When server 100 receives a packet, the server first determines the packet's application group, and the corresponding contention pool (step 33). Server 100 increments the flow meter of the contention pool for the direction the packet is going, e.g., incoming or outgoing (step 35). If the flow rate as indicated by the value of the flow meter exceeds the allocated bandwidth of the contention pool, the server will drop the packet (step 37). If the value of the flow meter does not exceed the allocated bandwidth, the packets are queued for transmission.

Traffic from application groups that have not been explicitly assigned to a contention pool or from application groups that arrive from an unexpected link or source will use a leftover bandwidth on the link allocation. Referring again to FIG. 2, a REST flow meter limits traffic belonging to such application groups.

Statistics are generated for each contention pool to assure the network manager that the server is providing the desired bandwidth management. The statistics include indications of peak, average, and actual bandwidth utilization over time for each contention pool, along with the number of dropped packets or frames caused by bandwidth limitations. For remote access applications, the peak, average, and actual number of connected users is also indicated. Additionally, traffic from unassigned sources are metered, and statistically analyzed. The unassigned sources are also recorded to provide a clear indication of where the traffic is coming from.

A number of embodiments of the invention have been described. Nevertheless, it will be understood that various modifications may be made without departing from the spirit and scope of the invention. For example, server 100 may be a Web server. Accordingly, other embodiments are within the scope of the following claims.

What is claimed is:

1. A method for a server that manages bandwidth of a remote link, comprising:
assigning a portion of the bandwidth to at least one application group; and
metering packets belonging to the application group.

2. The method of claim 1 wherein the server is a VPN server.

3. The method of claim 1 wherein the server is directly connected to other links having larger bandwidth than the available bandwidth of the remote link.

4. The method of claim 1 wherein the packets belonging to the application group share a pre-defined configuration.

5. The method of claim 1 wherein the packets belonging to the application group contend equally for the portion of the bandwidth.

6. The method of claim 1 wherein metering the packets group further includes metering flow rate of the packets going through the server in either direction.

7. The method of claim 6 wherein metering the packets further includes rejecting the packets if the flow rate exceeds the portion of the assigned bandwidth.

8. The method of claim 1 further comprising allowing a user to specify the bandwidth of the remote link from a user interface.

9. The method of claim 1 further comprising allowing a user to specify the portion of the assigned bandwidth from a user interface.

10. A system for managing bandwidth of a remote link comprising:
a server
a contention pool having a portion of the bandwidth for at least one application group; and
a meter for metering the packets belonging to the application group.

11. The system of claim 10 wherein the server is a VPN server.

12. The system of claim 10 wherein the server is directly connected to other links having larger bandwidth than the available bandwidth of the remote link.

13. The system of claim 10 wherein the packets belonging to the application group share a pre-defined configuration.

14. The system of claim 10 wherein the packets belonging to the application group contend equally for the contention pool.

15. The system of claim 10 wherein the meter further meters flow rate of the packets going through the server in either direction.

16. The system of claim 15 wherein the meter further rejects the packets if the flow rate exceeds the assigned portion of the bandwidth.

17. The system of claim 10 further comprising a user interface that allows a user to specify the bandwidth of the link.

18. The system of claim 10 further comprising a user interface that allows a user to specify the assigned portion of the bandwidth.
